(19) United States
(12) Patent Application Publication
(10) Pub. No.: US 2025/0102949 A1
(43) Pub. Date: Mar. 27, 2025

(54) DEVELOPING DEVICE AND IMAGE FORMING APPARATUS

(71) Applicant: FUJIFILM Business Innovation Corp., Tokyo (JP)

(72) Inventors: Kenta URAYAMA, Kanagawa (JP); Norihiro TAMAZAWA, Kanagawa (JP); Tomoyuki YOSHII, Kanagawa (JP); Yujiro FUKUDA, Kanagawa (JP); Shinichi KURAMOTO, Kanagawa (JP); Shigemi MURATA, Kanagawa (JP); Yutaka KIUCHI, Kanagawa (JP); Shota OBA, Kanagawa (JP); Yoshifumi OZAKI, Kanagawa (JP); Daisuke UCHIMITSU, Kanagawa (JP)

(73) Assignee: FUJIFILM Business Innovation Corp., Tokyo (JP)

(21) Appl. No.: 18/595,434

(22) Filed: Mar. 5, 2024

(30) Foreign Application Priority Data
Sep. 26, 2023 (JP) 2023-162916

(51) Int. Cl. G03G 15/08

(52) U.S. Cl. CPC G03G 15/0812

(57) ABSTRACT

A developing device includes a developer holder that holds a developer containing toner and carrier and being supplied to an image holder forming an electrostatic latent image; a regulation member that regulates the developer held on the developer holder to a specified amount; and a member that is provided to decrease a space on a lower side of the regulation member, and is provided in a region that is less flexible compared to other regions of the regulation member in an axial direction of the developer holder.

### CROSS-REFERENCE TO RELATED APPLICATIONS

This application is based on and claims priority under 35 USC 119 from Japanese Patent Application No. 2023-162916 filed Sep. 26, 2023.

### BACKGROUND

### (i) Technical Field

The present invention relates to a developing device and an image forming apparatus.

### (ii) Related Art

For example, JP2020-173336A discloses a developing apparatus comprising: a conveyance member that conveys a developer while rotating, a developing section that develops an electrostatic latent image of an image holder, a rotation member that rotates in a circumferential direction, a supply section that supplies the developer to the developing section by sticking the developer conveyed by the conveyance member due to the magnetic force and releasing the stuck developer from the rotation member, and a variable mechanism that changes the amount of developer supplied from the supply section to the developing section.

### SUMMARY

Here, in a developing device including at least a developer holder that holds the developer and a regulation member that regulates the amount of developer with respect to the developer holder, as constructional members, in a case where the developer regulated by the regulation member remains in a space between the constructional members, the amount of developer used is decreased.

Aspects of non-limiting embodiments of the present disclosure relate to a developing device and an image forming apparatus that suppress a decrease in the amount of developer used as compared with a case where a state in which the developer remains in a space between the constructional members continues.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a developing device including a developer holder that holds a developer containing toner and carrier and being supplied to an image holder forming an electrostatic latent image; a regulation member that regulates the developer held on the developer holder to a specified amount; and a member that is provided to decrease a space on a lower side of the regulation member, and is provided in a region that is less flexible compared to other regions of the regulation member in an axial direction of the developer holder.

### BRIEF DESCRIPTION OF THE DRAWINGS

Exemplary embodiment(s) of the present invention will be described in detail based on the following figures, wherein:

FIG. 1 is a diagram illustrating an image forming apparatus;

FIGS. 2A and 2B are diagrams illustrating a developing device of the image forming apparatus, FIG. 2A illustrates a first configuration example, and FIG. 2B illustrates a second configuration example;

FIG. 3 is a perspective view illustrating a more specific configuration of the developing device according to the first configuration example;

FIG. 4 is a perspective view illustrating a more specific configuration of the developing device according to the first configuration example;

FIGS. 5A and 5B are longitudinal cross-sectional views illustrating various shapes of a limiting member in the first configuration example, FIG. 5A illustrates a first shape example, and FIG. 5B illustrates a second shape example;

FIGS. 6A and 6B are longitudinal cross-sectional views illustrating various shapes of the limiting member in the first configuration example, FIG. 6A illustrates a third shape example, and FIG. 6B illustrates a fourth shape example;

FIGS. 7A to 7C are perspective views illustrating other configurations of a limiting portion, and illustrate the limiting member; and

FIG. 8 is a graph illustrating a size of a block depending on a position in an axial direction, where the vertical axis indicates the size of the block and the horizontal axis indicates the position in the axial direction.

### DETAILED DESCRIPTION

Hereinafter, exemplary embodiments of the invention will be described in detail with reference to the accompanying drawings.

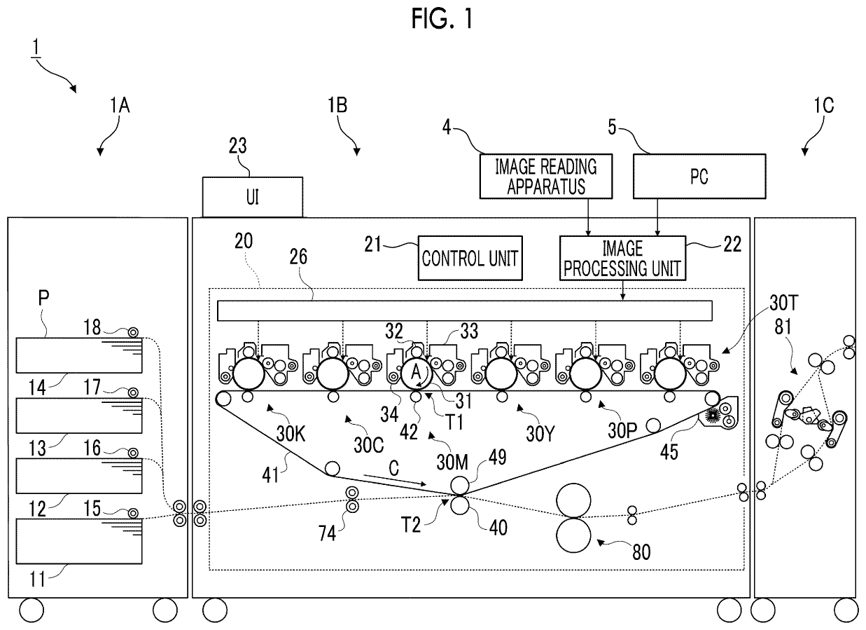

FIG. 1 is a diagram illustrating an image forming apparatus 1.

The image forming apparatus 1 according to the present exemplary embodiment includes a paper feeding unit 1A, a printing unit 1B, and a paper discharge unit 1C.

The paper feeding unit 1A includes a first paper accommodation portion 11 to a fourth paper accommodation portion 14 that accommodate paper P as an example of a recording medium.

In addition, the paper feeding unit 1A is provided with feeding rolls 15 to 18 that are provided respectively corresponding to the first paper accommodation portion 11 to the fourth paper accommodation portion 14, and that feed the paper P accommodated in each paper accommodation portion to a conveyance route connected to the printing unit 1B.

The printing unit 1B includes an image forming portion 20 that forms an image on the paper P. In addition, the printing unit 1B is provided with a control unit 21 that controls each unit of the image forming apparatus 1.

In addition, the printing unit 1B also includes an image processing unit 22. The image processing unit 22 performs image processing on image data transmitted from an image reading apparatus 4 and a personal computer (PC) 5.

In addition, the printing unit 1B is provided with a user interface (UI) 23 that is configured by a touch panel or the like and that notifies a user of information and receives an input of information from the user.

The image forming portion 20 as an example of an image forming section is provided with six image forming units 30T, 30P, 30Y, 30M, 30C, and 30K (hereinafter simply referred to as “image forming unit 30”) arranged in parallel at regular intervals.

Each image forming unit 30 includes a photosensitive drum 31 on which an electrostatic latent image is formed while rotating in a direction of arrow A, a charging roll 32 that charges a surface of the photosensitive drum 31, a developing device 33 that develops the electrostatic latent image formed on the photosensitive drum 31, and a drum cleaner 34 that removes toner or the like on the surface of the photosensitive drum 31.

In addition, the image forming portion 20 is provided with a laser exposure device 26 that exposes each photosensitive drum 31 of each image forming unit 30 with laser light.

Note that the exposure of the photosensitive drum 31 by the laser exposure device 26 is not limited to using laser light. For example, each image forming unit 30 may be provided with a light source such as a light emitting diode (LED), and the exposure of the photosensitive drum 31 may be performed using light emitted from the light source.

The respective image forming units 30 have a similar configuration except for the toner housed in the developing device 33. The image forming units 30Y, 30M, 30C, and 30K form yellow (Y), magenta (M), cyan (C), and black (K) toner images, respectively.

In addition, the image forming units 30T and 30P form toner images using toner corresponding to corporate colors, foamed toner for braille, fluorescent toner, toner to improve glossiness, and the like. In other words, the image forming units 30T and 30P form toner images using special color toner.

In addition, the image forming portion 20 is provided with an intermediate transfer belt 41 to which the toner image of each color formed on the photosensitive drum 31 of each image forming unit 30 is transferred.

In addition, the image forming portion 20 is provided with a primary transfer roll 42 that transfers each color toner image of each image forming unit 30 onto the intermediate transfer belt 41 at a primary transfer portion T1.

In addition, the image forming portion 20 is provided with a secondary transfer roll 40 that transfers the toner images transferred onto the intermediate transfer belt 41 all at once onto the paper P at a secondary transfer portion T2.

Further, the image forming portion 20 is provided with a belt cleaner 45 that removes toner or the like on the surface of the intermediate transfer belt 41, and a fixing device 80 that fixes the secondarily transferred image onto the paper P.

The image forming portion 20 performs an image forming operation on the basis of a control signal from the control unit 21.

Specifically, in the image forming portion 20, first, image processing is performed by the image processing unit 22 on the image data input from the image reading apparatus 4 or the PC 5, and the image data after the image processing is performed is supplied to the laser exposure device 26.

Then, for example, in the image forming unit 30M for magenta (M), after the surface of the photosensitive drum 31 is charged by the charging roll 32, the photosensitive drum 31 is irradiated by the laser exposure device 26 with the laser light modulated with the image data obtained from the image processing unit 22.

In this manner, the electrostatic latent image is formed on the photosensitive drum 31.

The formed electrostatic latent image is developed by the developing device 33, and a magenta toner image is formed on the photosensitive drum 31.

Similarly, in the image forming units 30Y, 30C, and 30K, yellow, cyan, and black toner images are formed, and in the image forming units 30T and 30P, special color toner images are formed.

Each color toner image formed in each image forming unit 30 is sequentially electrostatically transferred by the primary transfer roll 42, onto the intermediate transfer belt 41 that rotates in a direction of arrow C in FIG. 1, and superimposed toner images are formed on the intermediate transfer belt 41.

The superimposed toner images formed on the intermediate transfer belt 41 are conveyed to the secondary transfer portion T2 that is configured by the secondary transfer roll 40 and a backup roll 49, as the intermediate transfer belt 41 is moved.

On the other hand, the paper P is taken out from the first paper accommodation portion 11 by, for example, the feeding roll 15, and then is conveyed to a position of a registration roll 74 via the conveyance route.

In a case where the superimposed toner images are conveyed to the secondary transfer portion T2, the paper P is supplied from the registration roll 74 to the secondary transfer portion T2 at the same time.

Then, at the secondary transfer portion T2, the superimposed toner images are electrostatically transferred all at once onto the paper P by the action of a transfer electric field formed between the secondary transfer roll 40 and the backup roll 49.

Thereafter, the paper P on which the superimposed toner images have been electrostatically transferred is conveyed to the fixing device 80.

In the fixing device 80, the paper P on which the unfixed toner image is formed is pressurized and heated, and fixing processing of the toner image on the paper P is performed.

Then, the paper P on which the fixing processing has been performed is conveyed to a paper stacking portion (not illustrated) after passing through a curl correction portion 81 provided in the paper discharge unit 1C.

The photosensitive drum 31 is an example of an image holder in the image forming apparatus, the developing device 33 is an example of a developing section, the secondary transfer portion T2 is an example of a transfer section, and the fixing device 80 is an example of a fixing section.

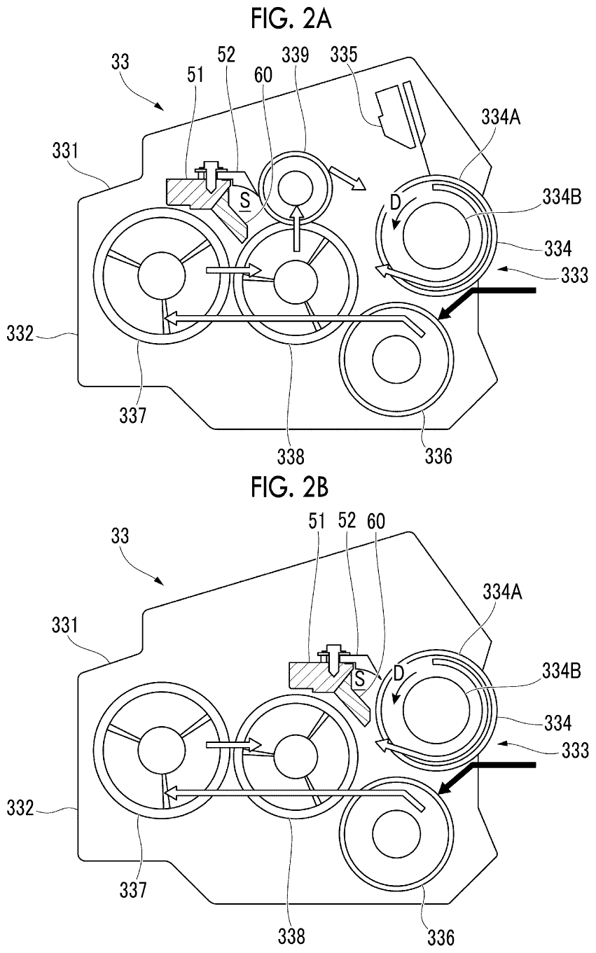

FIGS. 2A and 2B are diagrams illustrating the developing device 33 of the image forming apparatus 1, FIG. 2A illustrates a first configuration example, and FIG. 2B illustrates a second configuration example. Note that FIGS. 2A and 2B illustrate the developing device 33 viewed from the rear side.

As illustrated in FIG. 2A, the developing device 33 according to the first configuration example includes an accommodation portion 331 that accommodates a developer therein. The accommodation portion 331 is configured by an accommodation case 332 made of resin.

The accommodation case 332 of the developing device 33 is arranged to extend along a direction perpendicular to the paper surface of FIGS. 2A and 2B, which is a direction from the front side to the rear side of the image forming apparatus 1 (refer to FIG. 1), and has a back side end portion (not illustrated) on the rear side and a front side end portion (not illustrated) on the front side.

The accommodation case 332 is provided with an opening portion 333 at a location facing the photosensitive drum 31 (refer to FIG. 1). A developing roll 334 that causes the developer to adhere to the surface of the photosensitive drum 31 is provided in the opening portion 333.

The developing roll 334 is formed in a cylindrical shape, and is arranged to extend along the direction from the front side to the rear side of the image forming apparatus 1. Additionally, the developing roll 334 is arranged along a longitudinal direction of the developing device 33.

The developing roll 334 is provided with a developing sleeve 334A that is configured by a cylindrical body and is rotationally driven, and with a magnet roll 334B arranged on the inner side of the developing sleeve 334A.

The developing sleeve 334A is configured by metal such as SUS, for example. In addition, the developing sleeve 334A rotates in a direction of arrow D in the figure.

Further, in the present exemplary embodiment, the developing sleeve 334A and the photosensitive drum 31 rotate such that the developing sleeve 334A and the photosensitive drum 31 are moved in the same direction at the primary transfer portion T1 (refer to FIG. 1) between the developing roll 334 and the photosensitive drum 31.

The developing device 33 is provided with a layer regulating member 335 that regulates a layer thickness of the developer held on the developing roll 334.

In addition, as illustrated in FIGS. 2A and 2B, the developing device 33 is provided with a first conveyance member 336 and a second conveyance member 337 that convey the developer.

The first conveyance member 336 and the second conveyance member 337 are provided on a side opposite to the side where the photosensitive drum 31 (refer to FIG. 1) is installed, with the developing roll 334 interposed therebetween.

The first conveyance member 336 includes a rotation axis along a rotation axis of the developing sleeve 334A that is rotationally driven, rotates around the rotation axis, and conveys the developer in the accommodation portion 331.

In the developing device 33 configured as described above, new toner or toner to which a very small amount of carrier is added is conveyed in circulation by being agitated and conveyed between the first conveyance member 336 and the second conveyance member 337. More specifically, by delivering the developer through connection ports formed at both ends of a partition wall extending in an axial direction, the developer agitated by the first conveyance member 336 is agitated by the second conveyance member 337, and can be further agitated by the first conveyance member 336. In the developing device 33, circulation routes as routes circulating in the axial direction due to the rotation of each of the first conveyance member 336 and the second conveyance member 337 are formed.

In the developing device 33, a third conveyance member 338 adjacent to the second conveyance member 337 is provided. In addition, in the developing device 33, a pickup roll 339 positioned above the third conveyance member 338 is provided.

The developing device 33 is provided with a support member 51 that is positioned between the second conveyance member 337 and the pickup roll 339, and a layer regulating member 52 that is supported by the support member 51 and regulates a layer thickness of the developer held on the pickup roll 339. The layer regulating member 52 regulates the amount of developer held on the pickup roll 339 to a specified amount.

In addition, the developing device 33 is provided with a limiting portion 60 that is supported by the support member 51 and is positioned below the layer regulating member 52. The limiting portion 60 is provided to decrease a space S below the layer regulating member 52.

The conveyance route formed by the rotation of the third conveyance member 338 is connected to the above-mentioned circulation route, and the developer from the circulation route is delivered. The third conveyance member 338 supplies the developer to the pickup roll 339. The pickup roll 339 supplies the developer to the developing roll 334.

For example, the first conveyance member 336 performs the conveyance to the front side of the page, the second conveyance member 337 performs the conveyance to the back side of the page, and the third conveyance member 338 performs the conveyance to the front side of the page.

Note that the developing roll 334, the layer regulating member 335, the first conveyance member 336, the second conveyance member 337, the third conveyance member 338, the pickup roll 339, the support member 51, and the layer regulating member 52 are arranged substantially parallel to the photosensitive drum 31 (refer to FIG. 1).

In the first configuration example, the pickup roll 339 holds the developer to be supplied to the developing roll 334.

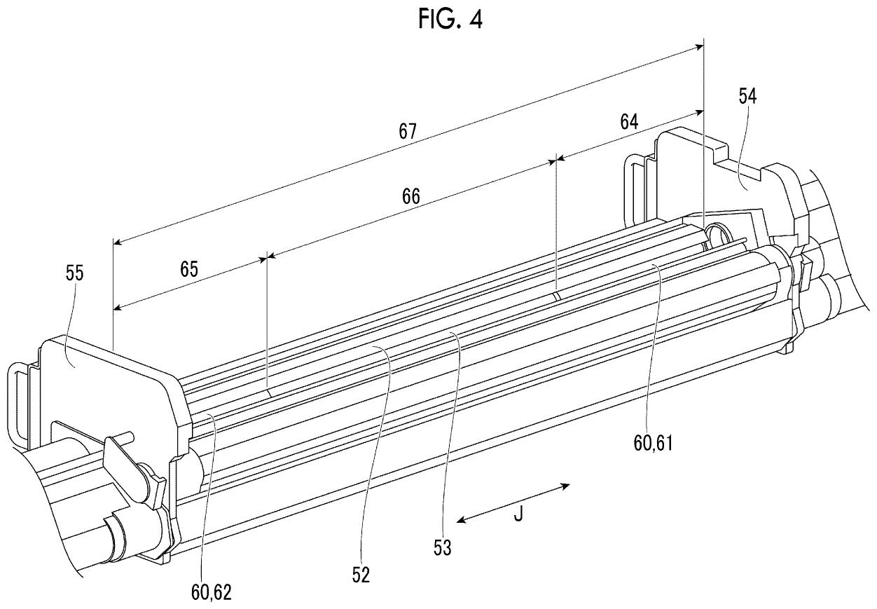

The developing roll 334 is an example of the image holder, the pickup roll 339 is an example of the developer holder, the layer regulating member 52 is an example of the regulation member, and limiting members 61 and 62 (refer to FIG. 4) of the limiting portion 60, which will be described later, are examples of a member.

Since the second configuration example illustrated in FIG. 2B has the same basic configuration as the first configuration example described above, the same reference numerals are used for common parts, and the description thereof may be omitted.

In the developing device 33 according to the second configuration example, the pickup roll 339 and the layer regulating member 335 that are included in the first configuration example are not provided. In addition, in the second configuration example, the support member 51, the layer regulating member 52, and the limiting portion 60 have different positions from the positions in the first configuration example, and are positioned between the developing roll 334 and the third conveyance member 338.

More specifically, in the second configuration example, the developing roll 334 of the developing device 33 holds the developer to be supplied to the photosensitive drum 31 (refer to FIG. 1). The layer regulating member 52 regulates the amount of developer held on the developing roll 334 to a specified amount.

The photosensitive drum 31 is an example of the image holder, the developing roll 334 is an example of the developer holder, the layer regulating member 52 is an example of the regulation member, and the limiting members 61 and 62 (refer to FIG. 4) of the limiting portion 60, which will be described later, are examples of the member.

Next, a more specific configuration of the developing device 33 according to the first configuration example will be described.

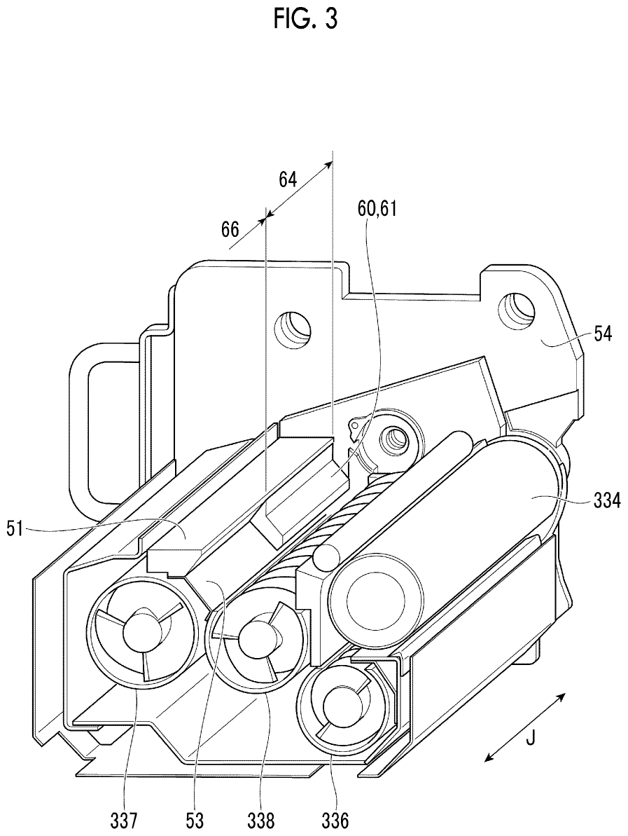

FIGS. 3 and 4 are perspective views illustrating a more specific configuration of the developing device 33 according to the first configuration example, and illustrate a state where the pickup roll 339 positioned above the third conveyance member 338 is removed. More specifically, FIG. 3 illustrates a state where the layer regulating member 52 (refer to FIG. 2A) is removed, and FIG. 4 illustrates a state where the layer regulating member 52 is attached. Note that, in FIGS. 3 and 4, the descriptions of the parts common to the reference numerals illustrated in FIGS. 2A and 2B may be omitted.

As illustrated in FIG. 3, the developing device 33 includes an attachment member 53 attached to the lower surface of the support member 51. The limiting member 61 constituting a part of the limiting portion 60 is attached to the attachment member 53. That is, the support member 51 supports the limiting member 61 via the attachment member 53.

The limiting member 61 is arranged at an end portion 64 of the pickup roll 339 (for example, refer to FIG. 2A) in the axial direction J. The end portion 64 in the axial direction J here refers to a position closer to a plate-shaped member 54 that holds the developing roll 334 and the like of the developing device 33, and is a region that is less flexible than other regions, for example, the position of a central portion 66, other than the end portion 64 in the axial direction J.

In more detail, in the case illustrated in FIG. 3, the limiting member 61 is arranged at the end portion 64 in the axial direction J which is less flexible, and is not arranged at the flexible central portion 66. In other words, the limiting portion 60 is arranged in a region excluding the central portion 66 in the axial direction J.

The central portion 66 is an example of an intermediate portion, and the end portion 64 is an example of a region excluding the intermediate portion. Note that the axial direction J is the same direction as the depth direction (direction perpendicular to the paper surface of FIG. 1) of the image forming apparatus 1.

The limiting portion 60 will be described in more detail.

As illustrated in FIG. 4, the limiting portion 60 includes the limiting member 61 provided at the end portion 64 described above, and the limiting member 62 provided at an end portion 65. The limiting member 62 is provided at a position closer to a plate-shaped member 55.

In this manner, the layer regulating member 52 is provided over the entire section of a section 67 sandwiched between the plate-shaped members 54 and 55 that are arranged apart from each other, that is, over the end portions 64 and 65 and the central portion 66. On the other hand, the limiting members 61 and 62 of the limiting portion 60 are provided at the end portions 64 and 65 that are regions excluding the central portion 66.

Therefore, the developer regulated by the layer regulating member 52 remains in the space S (for example, refer to FIG. 2A) between constructional members, that is, between the pickup roll 339, and the second conveyance member 337 and the third conveyance member 338, by the limiting portion 60. However, in the present exemplary embodiment, focusing on the axial direction J, since a configuration is adopted in which the limiting portion 60 is formed by the limiting member 61 provided at the end portion 64 and the limiting member 62 provided at the end portion 65 and the limiting member is not provided at the central portion 66, the limited developer falls from the central portion 66, and returns to the circulation route by the second conveyance member 337 and the third conveyance member 338. Therefore, since the amount of developer that becomes unusable is decreased by the developer remaining in the space between the constructional members, a decrease in the amount of developer that can be supplied to the developing roll 334 is suppressed.

Note that, in the present exemplary embodiment, a configuration is adopted in which the limiting members 61 and 62 are provided at the end portions 64 and 65 that are both end portions, but a member constituting a part of the limiting portion 60 may be provided at any one of the end portions 64 and 65. That is, there is a configuration in which the limiting member 61 is provided at the end portion 64 and the limiting member 62 is not provided at the end portion 65, or a configuration in which the limiting member 62 is provided at the end portion 65 and the limiting member 61 is not provided at the end portion 64.

Next, various shapes of the limiting members 61 and 62 will be described.

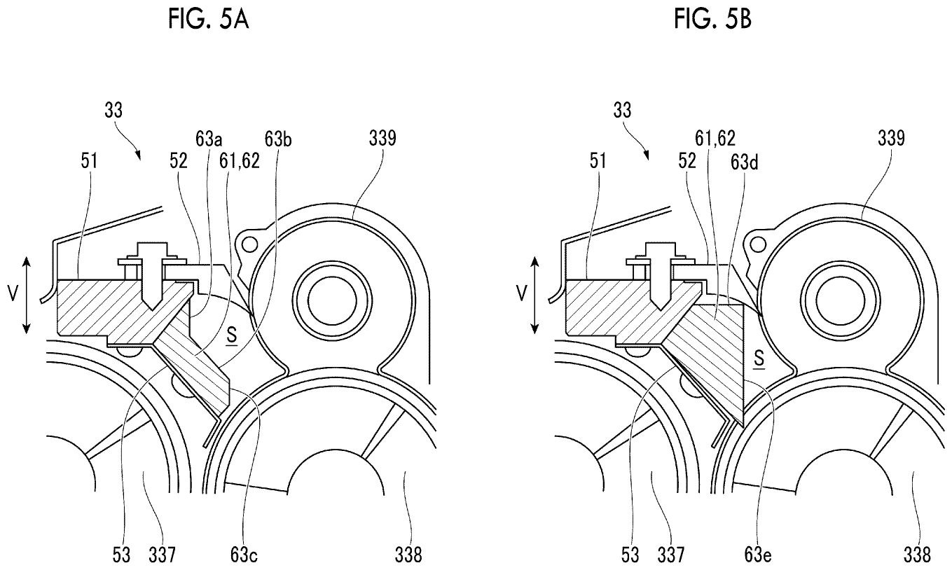

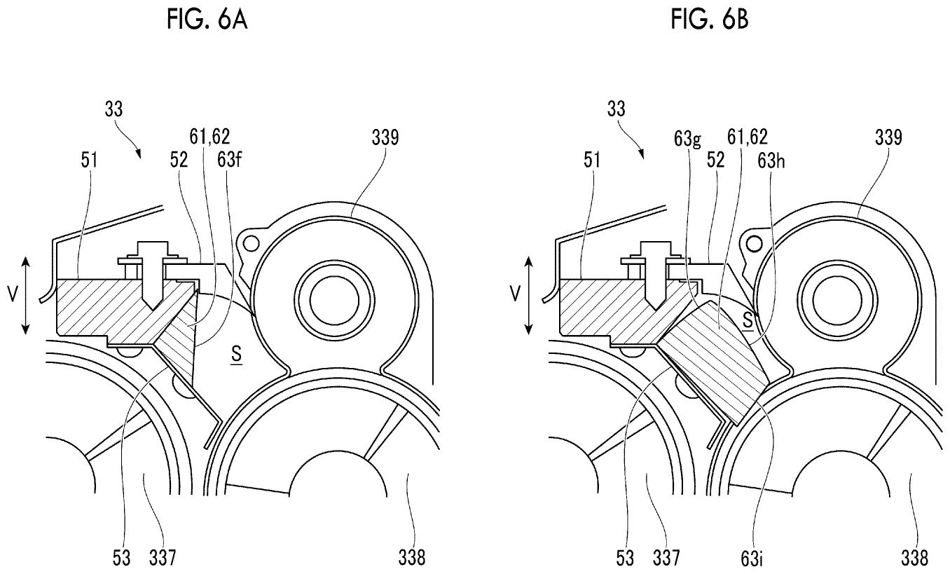

FIGS. 5A to 6B are longitudinal cross-sectional views illustrating various shapes of the limiting members 61 and 62 in the first configuration example, FIG. 5A illustrates a first shape example, FIG. 5B illustrates a second shape example, FIG. 6A illustrates a third shape example, and FIG. 6B illustrates a fourth shape example.

Note that, in FIGS. 5A to 6B, the limiting member 61 and the limiting member 62 have the same shape, and the description will be made without distinguishing the limiting members. In addition, the shape in the second configuration example (refer to FIG. 2B) can be similar to the shape in the first configuration example (refer to FIG. 2A), and the description thereof is omitted.

The limiting members 61 and 62 according to the first shape example illustrated in FIG. 5A include, as surfaces facing the layer regulating member 52 in a case where the limiting members 61 and 62 are attached to the attachment member 53, a surface 63a that is positioned below the layer regulating member 52 to extend in an up-down direction V, a surface 63b that is connected to a lower end of the surface 63a and is inclined with respect to the surface 63a in a direction toward the third conveyance member 338, and a surface 63c that extends parallel to the surface 63a from the lower end of the surface 63b. The surfaces 63a to 63c are continuously formed.

In the first shape example, the surfaces 63a to 63c of the limiting members 61 and 62 are surfaces facing the layer regulating member 52, and are defined by the positional relationship with the pickup roll 339. More specifically, the surface 63b is defined in a relationship that the distance from the pickup roll 339 is the same as in a case of being toward the lower side in the up-down direction V.

The limiting members 61 and 62 according to the second shape example illustrated in FIG. 5B include, as surfaces facing the layer regulating member 52 in a case where the limiting members 61 and 62 are attached to the attachment member 53, a surface 63d that is positioned below the layer regulating member 52 to extend toward the pickup roll 339 in the lateral direction, and a surface 63e that extends downward in the up-down direction V from an end portion of the surface 63d. The surfaces 63d and 63e are continuously formed.

In the second shape example, the surfaces 63d and 63e of the limiting members 61 and 62 are surfaces facing the layer regulating member 52, and are defined by the positional relationship with the pickup roll 339. More specifically, the surface 63e is defined in a relationship that the distance from the pickup roll 339 is increased toward the lower side in the up-down direction V.

The limiting members 61 and 62 according to the third shape example illustrated in FIG. 6A include, as surfaces facing the layer regulating member 52 in a case where the limiting members 61 and 62 are attached to the attachment member 53, a surface 63f that is positioned below the layer regulating member 52 to extend from the upper end toward the lower end in the up-down direction V.

In the third shape example, as in the above-described second shape example (refer to FIG. 5B), the surface 63f is defined in a relationship that the distance from the pickup roll 339 is increased toward the lower side in the up-down direction V.

The limiting members 61 and 62 according to the fourth shape example illustrated in FIG. 6B include, as surfaces facing the layer regulating member 52 in a case where the limiting members 61 and 62 are attached to the attachment member 53, a surface 63g that is positioned below the layer regulating member 52 to extend obliquely upward toward the layer regulating member 52, a surface 63h that extends downward from the upper end of the surface 63g and has an arc shape with a gently protruding shape toward the pickup roll 339, and a surface 63i that extends from the lower end of the surface 63h in a direction away from the pickup roll 339. The surfaces 63g to 63i are continuously formed.

In the fourth shape example, as in the above-described first shape example (refer to FIG. 5A), the surface 63h is defined in a relationship that the distance from the pickup roll 339 is the same as in a case of being toward the lower side in the up-down direction V.

In the first shape example and the fourth shape example described above, since the space of the space S is configured to be decreased, a decrease in the amount of developer used is suppressed.

In addition, in the second shape example and the third shape example described above, since the developer regulated by the layer regulating member 52 does not remain in the space S but easily falls, a decrease in the amount of developer used is suppressed.

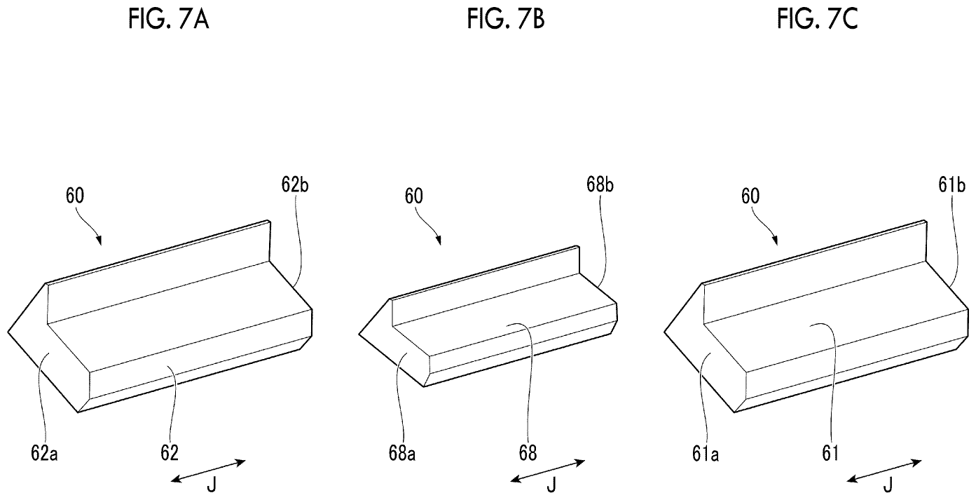

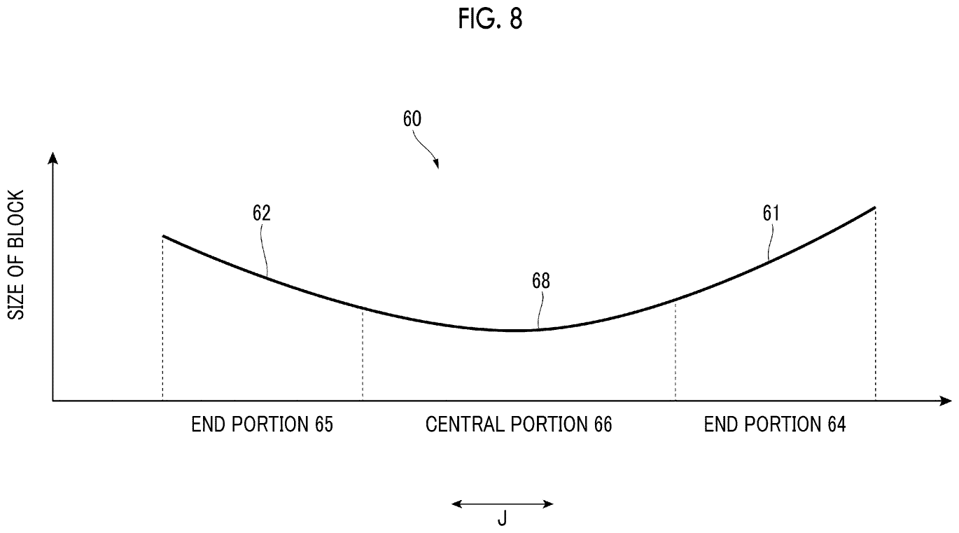

FIGS. 7A to 7C are perspective views illustrating other configurations of the limiting portion 60, FIG. 7A illustrates the limiting member 62, FIG. 7B illustrates a limiting member 68, and FIG. 7C illustrates the limiting member 61. In addition, FIG. 8 is a graph illustrating a size of a block depending on the position in the axial direction J, where the vertical axis indicates the size of the block and the horizontal axis indicates the position in the axial direction J.

The limiting portion 60 includes the limiting member 68 illustrated in FIG. 7B in addition to the limiting members 62 and 61 illustrated in FIGS. 7A and 7C. In more detail, an end surface 62b of the limiting member 62 is adjacent to an end surface 68a of the limiting member 68, and an end surface 68b of the limiting member 68 is adjacent to an end surface 61a of the limiting member 61. That is, the limiting members 62, 68, and 61 are provided in a line along the axial direction J.

In more detail, in the configuration of the limiting portion 60 illustrated in FIGS. 7A to 7C, the limiting member 68 is provided also at the central portion 66. In this respect, the configuration illustrated in FIGS. 7A to 7C is different from the configuration illustrated in FIG. 4 in which a member constituting a part of the limiting portion 60 is not provided at the central portion 66.

As illustrated in FIG. 8, the sizes of the blocks of the limiting members 61, 62, and 68 are changed depending on the position in the axial direction J. That is, the size at the central position in the axial direction J when the limiting members 61, 62, and 68 are arranged in a line is the smallest. Then, the size of the block is increased as the block is away from the central position. The size of the block here refers to a size of the cross-sectional area.

As illustrated in FIG. 8, the cross-sectional area of the limiting member 68 is smaller than the cross-sectional areas of the limiting members 62 and 61. In addition, regarding the cross-sectional areas of the limiting members 62 and 61, the end surfaces 62b and 61a closer to the limiting member 68 in the axial direction J are smaller than the end surfaces 62a and 61b far from the limiting member 68 in the axial direction J. Furthermore, the cross-sectional area of the limiting member 68 is decreased from the end surfaces 68a and 68b toward the center of the limiting member 68.

The limiting member 68 is an example of another member.

In this manner, in the end portions 64 and 65 as the region that is less flexible, the size of the block of the limiting portion 60 is large, while in the central portion 66 as the region that is flexible, the size of the block of the limiting portion 60 is small. In addition, the sizes of the limiting members 61, 62, and 68 are gradually changed in the axial direction J. Therefore, the developer that is regulated by the layer regulating member 52 to be at the end portions 64 and 65 moves toward the central portion 66 and falls, and thus a decrease in the amount of developer used is suppressed.

### SUPPLEMENTARY NOTE

(((1)))

A developing device comprising:
a developer holder that holds a developer containing toner and carrier and being supplied to an image holder forming an electrostatic latent image;
a regulation member that regulates the developer held on the developer holder to a specified amount; and
a member that is provided to decrease a space on a lower side of the regulation member, and is provided in a region that is less flexible compared to other regions of the regulation member in an axial direction of the developer holder.
(((2)))

The developing device according to (((1))),
wherein the region that is less flexible is provided in a region excluding an intermediate portion in the axial direction of the developer holder.
(((3)))

The developing device according to (((2))),
wherein the region excluding the intermediate portion is both end portions in the axial direction.
(((4)))

The developing device according to (((1))),
wherein the member is defined in a positional relationship between a surface of the member facing the regulation member and the developer holder.
(((5)))

The developing device according to (((4))),
wherein the positional relationship is a relationship that a distance to the developer holder is not changed even in a case of being toward the lower side.
(((6)))

The developing device according to (((4))),
wherein the positional relationship is that a distance to the developer holder is increased toward the lower side.
(((7)))

The developing device according to any one of (((1))) to (((6))),
wherein another member different from the member is provided in a region where the member is not provided, and
a cross-sectional area of the other member is smaller than a cross-sectional area of the member.
(((8)))

The developing device according to any one of (((1))) to (((6))),
wherein another member different from the member is provided in a region where the member is not provided, and
regarding a cross-sectional area of the member, an end portion closer to the other member in the axial direction is smaller than an end portion far from the other member.
(((9)))

The developing device according to (((7))) or (((8))),
wherein the cross-sectional area of the other member is decreased from end portions toward a center of the other member.
(((10)))

An image forming apparatus comprising:
an image holder that forms an electrostatic latent image;
a developing section that develops the electrostatic latent image formed on the image holder into a toner image;
a transfer section that transfers the toner image by the developing section onto a recording material; and
a fixing section that fixes the toner image transferred onto the recording material to the recording material,
wherein the developing section includes a developer holder that holds a developer containing toner and carrier and being supplied to the image holder forming the electrostatic latent image, a regulation member that regulates the developer held on the developer holder to a specified amount, and a member that is provided to decrease a space on a lower side of the regulation member, and is provided in a region that is less flexible compared to other regions of the regulation member in an axial direction of the developer holder.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A developing device comprising:
a developer holder that holds a developer containing toner and carrier and being supplied to an image holder forming an electrostatic latent image;
a regulation member that regulates the developer held on the developer holder to a specified amount; and
a member that is provided to decrease a space on a lower side of the regulation member, and is provided in a region that is less flexible compared to other regions of the regulation member in an axial direction of the developer holder.

2. The developing device according to claim 1,
wherein the region that is less flexible is provided in a region excluding an intermediate portion in the axial direction of the developer holder.

3. The developing device according to claim 2,
wherein the region excluding the intermediate portion is both end portions in the axial direction.

4. The developing device according to claim 1,
wherein the member is defined in a positional relationship between a surface of the member facing the regulation member and the developer holder.

5. The developing device according to claim 4,
wherein the positional relationship is a relationship that a distance to the developer holder is not changed even in a case of being toward the lower side.

6. The developing device according to claim 4,
wherein the positional relationship is that a distance to the developer holder is increased toward the lower side.

7. The developing device according to claim 1,
wherein another member different from the member is provided in a region where the member is not provided, and
a cross-sectional area of the other member is smaller than a cross-sectional area of the member.

8. The developing device according to claim 1,
wherein another member different from the member is provided in a region where the member is not provided, and
regarding a cross-sectional area of the member, an end portion closer to the other member in the axial direction is smaller than an end portion far from the other member.

9. The developing device according to claim 7,
wherein the cross-sectional area of the other member is decreased from end portions toward a center of the other member.

10. The developing device according to claim 8,
wherein the cross-sectional area of the other member is decreased from end portions toward a center of the other member.

11. An image forming apparatus comprising:
an image holder that forms an electrostatic latent image;
a developing section that develops the electrostatic latent image formed on the image holder into a toner image;
a transfer section that transfers the toner image by the developing section onto a recording material; and
a fixing section that fixes the toner image transferred onto the recording material to the recording material,
wherein the developing section includes a developer holder that holds a developer containing toner and carrier and being supplied to the image holder forming the electrostatic latent image, a regulation member that regulates the developer held on the developer holder to a specified amount, and a member that is provided to decrease a space on a lower side of the regulation member, and is provided in a region that is less flexible compared to other regions of the regulation member in an axial direction of the developer holder.
